(19) United States
(12) Patent Application Publication
(10) Pub. No.: US 2026/0145821 A1
(43) Pub. Date: May 28, 2026

(54) IMPACT DETECTION SYSTEM FOR AN UNMANNED AERIAL VEHICLE

(71) Applicant: University of South Carolina, Columbia, SC (US)

(72) Inventors: Li Ai, Knoxville, TN (US); Paul Ziehl, Irmo, SC (US)

(21) Appl. No.: 19/340,677

(22) Filed: Sep. 25, 2025

Related U.S. Application Data
(60) Provisional application No. 63/724,430, filed on Nov. 25, 2024.

(51) Int. Cl. B64U 20/30; B64D 45/00; B64U 20/80

(52) U.S. Cl. CPC B64U 20/30; B64D 45/00; B64U 20/80; B64D 2045/0085

(57) ABSTRACT

An impact detection system configured monitoring potential failure conditions on portions of panels that form a fuselage of an unmanned aerial vehicle (UAV) that may affect the structural integrity of a UAV as a result of detected impacts with foreign bodies thereon portions of selected panels of the UAV. The impact detection system can also provide for the identification of required maintenance resulting from the impact events so that corrective actions can be applied in a timely and cost-effective manner.

### CROSS-REFERENCE

The present Patent application claims benefit of U.S. Provisional Patent Application No. 63/724,430, filed Nov. 25, 2024, and the disclosure and figures of U.S. Provisional Patent Application No. 63/724,430, filed Nov. 25, 2024, are specifically incorporated by reference herein as if set forth in its entirety.

### GOVERNMENT SUPPORT CLAUSE

This invention was made with government support under Grant Number 1919-80NSSC21M0113, awarded by NASA. The government has certain rights in the invention.

### FIELD OF THE INVENTION

The present disclosure relates generally to systems, apparatus, and methods in the field of impact detection on surfaces of unmanned aerial vehicle(s) (“UAV”), and more particularly to various aspects involving systems, apparatus and methods for improved impact detection to include using diverse data sources to assess the location and magnitude of an impact event on a UAV and can include a structural monitoring system configured for localizing and characterizing damage during flight resulting from the impact event on the UAV.

### BACKGROUND

In general, the invention relates to ensuring a reliable operating state of an aircraft suitable for the air mobility (AAM) market, such as an UAV. UAVs are used, for example, for aerial photographs or for the transport of small goods, for example for parcel transport. At present, UAVs are generally operated without impact condition monitoring or with very rudimentary structural or fuselage monitoring systems. As a result, impending structural failures of fuselage components, such as the panels forming the fuselage or the landing skids, cannot be detected early. This increases the risk of loss of the UAV during operation. This is also associated with a risk to the environment, especially for people who are in the operating vicinity of such UAV.

The proposed invention differs from the current state of the maintenance practice for UAVs, in which damage of a certain size (for example, barely visible impact damage) is visually assessed after fight and is then repaired or investigated through follow-on visual inspections. In the disclosed invention, a repair assessment can be made based on data received and then evaluated primarily from in-flight sensing. and the cost of scheduled inspection and maintenance/repair becomes of interest.

In the context of AAM operations, various sources pose risks to operational use of UAVs, including natural events such as bird strikes, hailstorms, and man-made hazards such as debris. One will appreciate that certain types of runway/vertiport debris can consistently impact specific portions of a vehicle, assuming some consistency in debris type, size, and speed during takeoff or landing. One will also appreciate that, in areas with high bird populations, the average mass and flight speed of local bird species could lead to a degree of consistency in impact energy. However, the inherent randomness and unpredictability of these events result in large variations in impact energies.

Thus, there exists a need for a system and method of determining impact localization and impact energies on the UAV during in flight operations. Such a system and method can be low-weight and low-cost while also generating highly accurate impact localization and impact energies determination on the UAV.

### SUMMARY

To improve the state of the art, disclosed herein is an impact detection system, and methods of use thereof, utilizing novel functionalities. In embodiments and in combination with an unmanned aerial vehicle(s) (UAV), the impact detection system is configured to implement one or more of methods and systems of monitoring potential failure conditions that may affect the structural integrity of a UAV as a result of detected impacts. The disclosed methods and systems allow maintenance to perform corrective actions in a timely and cost-effective manner.

In embodiments, the monitoring methods and systems of the impact detection system is intended to monitor and support the functionality of physical structures associated with an UAV. In various examples, the physical structures of the UAV May include a fuselage comprising one or more panels that can include open-section or closed section structures formed from one or more of I-beams, U-beams, and the like. Each panel has a skin formed or attached thereto that has an outer surface and an opposed inner surface.

In various embodiments, the impact detection system can identify the location of the impact onto the skin of a respective panel and can determine an impact force applied to the skin of the panel by the respective impact. In some embodiments, a maintenance condition associated with a panel resulting from an impact event can describe damage to the skin of the panel.

In various embodiments, the impact detection system includes a plurality of sensors that monitor the operational functionality of select panels that form the UAV. In operation, it is contemplated that the impact detection system can acquire sensor data from each sensor and process the sensor data to determine whether the panels and or the skin of the panels is performing within its intended operational parameters.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIG. 1 schematically illustrates an example of a UAV showing a plurality of locations upon which a plurality of sensors can be attached that are configured to monitor the operational functionality of select panels that form the UAV. In operation, the plurality of sensors can include a plurality of acoustic emission sensors and a plurality of fiber-optic strain sensors. For each panel to which sensor are attached, it is preferred that one acoustic emission sensor and one fiber-optic strain sensor is attached in an inner surface of the selected panel.

FIG. 2 is a schematic diagram depicting an example environment for implementing the impact detection system.

FIG. 3 is a block diagram of an example impact detection system.

FIG. 4 is a block diagram on an example ground test system for the impact detection system.

FIG. 5 schematically shows a skid portion of the fuselage of an exemplary UAVi and shows one acoustic emission sensor operatively coupled to a predetermined position on the inner surface of the skin of the panel forming the skid portion and one fiber-optic strain sensor operatively coupled along a predetermined pattern along the inner surface of the skin of the panel.

FIG. 6 shows a schematic view of an exemplary panel of a UAV for an experimental test and sowing a plurality of acoustic emission sensors mounted to multiple locations thereon the inner surface of the panel. In operation, it is preferred that only one acoustic emission sensor is connected to the inner surface of the panel. The most preferred predetermined location of the single acoustic emission sensor is position 5 noted in the exemplary panel.

FIG. 7 shows a schematic view of an exemplary panel of a UAV for an experimental test and sowing a plurality of fiber-optic strain sensors mounted to multiple locations thereon the inner surface of the panel, with each fiber-optic strain sensor running along a predetermined pattern. In operation, it is preferred that only one fiber-optic strain sensor is connected to the inner surface of the panel. The most preferred pattern of the single fiber-optic strain sensor is the serpentine pattern identified as the “Fiber optic sensor 1” in the exemplary panel.

FIG. 8 is a flow diagram of an example process for determining the location and energy level of an impact event thereon a panel of the UAV.

FIG. 9 shows a demonstrator panel specimen that was employed to train and to assess the impact localization approach for data received from AE sensors.

FIG. 10 shows a perspective view of the demonstrator panel specimen pf FIG. 9, showing a plurality of AE sensors coupled to an inner surface of the panel and showing a preferred location of a single AE sensor embodiment, noted in the “Sensor 5” position.

FIG. 11 shows a representative waveform recorded during an impact experiment.

FIG. 12 shows a listing of the AE waveform signal features and descriptions of the features.

FIG. 13 shows an exemplary structure of a random forest regression model with 100 decision trees.

FIG. 14 graphically shows an exemplary estimation of impact energy (severity vs. Historic index.)

FIG. 15 schematically shows strain captured by a fiber optic sensor prior to, during, and after an impact event on the demonstration panel. The length axis represents the entire length of the respective fiber optic sensors. The effect of the impact event is clear in terms of both magnitude and location.

FIG. 16 shows an exemplary fiber optic strain reading for a typical impact event.

FIG. 17 depicts an exemplary data combination and nonlinear regression process that occurs to derive a high confidence level determination of the location and the magnitude of the applied energy resulting from the impact event.

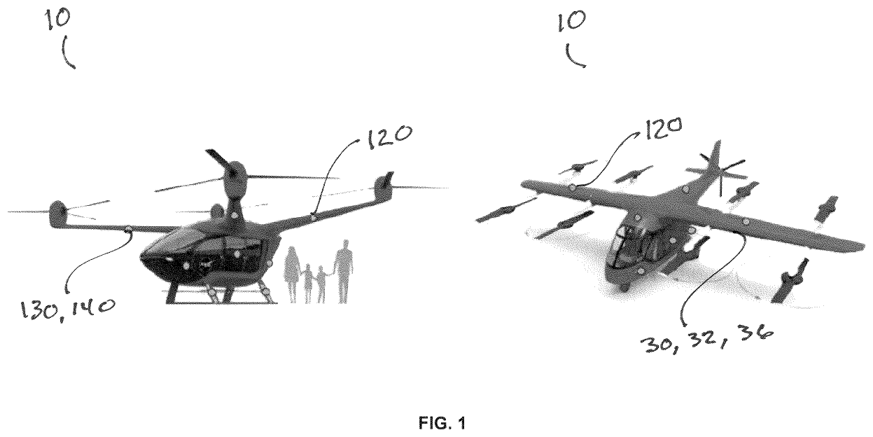

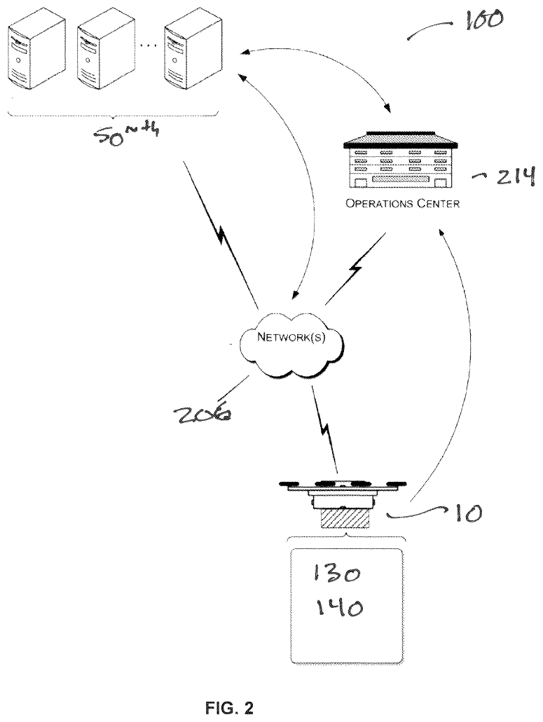

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a RFID seal” can include two or more such RFID seals unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a sensor” can include two or more such sensors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

Described herein are embodiments of an impact detection system. In some embodiments, the impact detection system beneficially provides users with accurate and meaningful information that they can use when determining the effect of impact events onto a UAV during operation, and/or whether maintenance is required to maintain the operational capability of the UAV.

This disclosure provides methods and systems for implementing an impact detection system 100 on unmanned aerial vehicle(s) (UAV). This disclosure further provides monitoring methods and systems of monitoring potential failure conditions that may affect the structural integrity of a UAV resulting from detected impacts. The disclosed methods and systems allow maintenance to perform corrective actions in a timely and cost-effective manner.

In embodiments, the monitoring methods and systems of the impact detection system 100 is intended to monitor and support the functionality of physical structures associated with an UAV 10, which can include, without limitation, the fuselage 20 and adjoining structure that forms the UAV. In various examples, the physical structures 20 of the UAV 10 can include a fuselage 20 comprising one or more panels 30 that can include open-section or closed section structures formed from one or more of I-beams, U-beams, and the like. Each panel 30 has a skin 32 formed or attached thereto that has an outer surface 34 and an opposed inner surface36. It is contemplated that the skin 32 of the panel can be formed from any conventional material, to include, without limitation, metal, metal alloys, composites, polymer composites, and the like. As one will appreciate, the panels 30 can, for example, be integrated together or otherwise configured to form a UAV fuselage 20 or other structural portions of the UAV, such as, for example, a landing skid structure.

In various embodiments, the impact detection system 100 can identify the location of the impact event onto the outer surface 36 of the skin 32 of a respective panel and can determine an impact force applied to the outer surface 36 of the skin 32 of the panel by the respective impact event. In some embodiments, a maintenance condition associated with a panel 30 resulting from an impact event can describe damage to the skin 32 of the panel, a complete tensile or compressive failure of the skin 32 of a panel, a yielding of the skin 32 of the panel, and/or a partial tensile or compressive failure of the skin 32 of the panel.

In various embodiments, the impact detection system 100 includes a plurality of sensors 120 that monitor the operational functionality of select panels that form the UAV 10. In operation, it is contemplated that the impact detection system 100 can acquire sensor data from each sensor and process the sensor data to determine whether the panels and or the skin of the panels is performing within its intended operational parameters.

In embodiments, the plurality of sensors 120 can comprise a plurality of acoustic emission sensors 130 and a plurality of fiber-optic strain sensors 140. In one example, and as shown, for selected panels of the UAV, at least one acoustic emission sensor of the plurality of acoustic emission sensors 130 can be operatively coupled to a predetermined position on the inner surface 34 of the skin 32 of the panel and at least one fiber-optic strain sensor of the plurality of fiber optic strain sensors 140 can be operatively coupled along a predetermined pattern on the inner surface 34 of the skin 32 of the panel. In exemplary examples, and without limitation, the predetermined pattern of the positioned fiber-optic strain sensor can have a serpentine shape, a box shape, or any other non-overlapping geometric shape.

In embodiments, it is contemplated that each panel 30 of the UAV 10 that forms a portion of the impact detection system 100 can have one acoustic emission sensor and one fiber-optic strain sensor that are positioned at known locations on the inner surface 34 of the skin 32 of the panel. Optionally, it is contemplated that each panel of the UAV that forms a portion of the impact detection system 100 can have two or more acoustic emission sensor and/or two or more fiber-optic strain sensors that are each positioned at known locations on the inner surface of the skin of the panel.

In embodiments, the impact detection system 100 can be programmed to identify if a maintenance condition has occurred as a result of impact event(s) onto the UAV 10. In embodiments, the impact detection system 100 can cause a message to be transmitted to a maintenance center identifying the maintenance condition, and particularly can identify the location and potential severity of the maintenance condition on an identified panel 30 of the UAV 10 resulting from an impact event. In various embodiments, the impact detection system 100 can impose a restriction on continued flight until a corrective maintenance action has been performed.

In embodiments, it is contemplated that the impact detection system 100 can be implemented using distributed computing resources 204 that can communicate with one another and with external devices via one or more network(s) 206. For example, the one or more network(s) 206 can include public networks such as the Internet, private networks such as an institutional and/or personal intranet, or some combination of private and public networks. Network(s) can also include any type of wired and/or wireless network, including but not limited to local area network (LANs), wide area networks (WANs), satellite networks, cable networks, Wi-Fi network, WiMax networks, mobile communications networks (e.g. 3G, 4G, and so forth), Bluetooth or near field communication (NFC) networks, or any combination thereof.

In one exemplary embodiment, the UAV 10 can be configured to transmit sensor data from at least one of the plurality of acoustic emission sensors 130 and/or at least one of the plurality of fiber-optic strain sensors 140 to the impact detection system 100 via the one or more network(s) 206. In other embodiments, the UAV 10 can interact with an impact detection system 100 that is stored locally on the UAV 10.

In some embodiments, the impact detection system 100 can also communicate with an operations center 214, either directly or via the one or more network(s) 106. In embodiments, the operations center 214 can be tasked with supporting the operation of the UAV 10 by maintaining the operational maintenance integrity of the UAV.

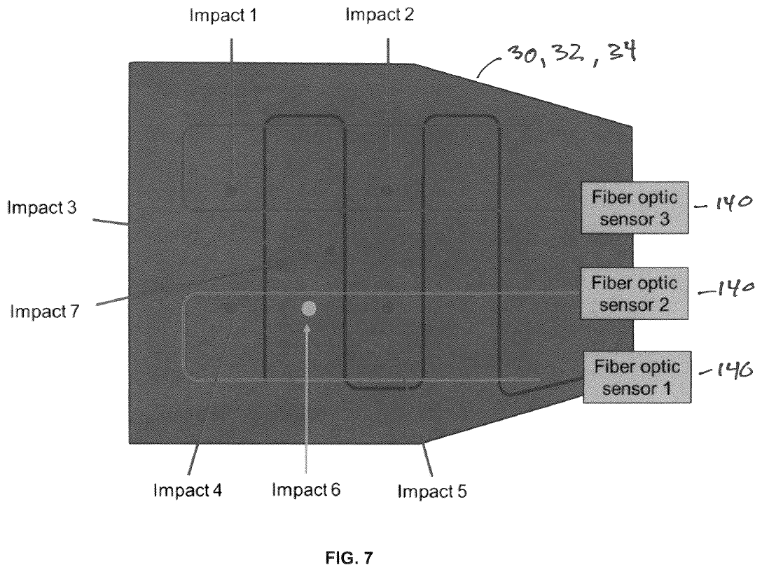

FIGS. 6 and 7 show an exemplary UAV 10 showing exemplar panels upon which at least one acoustic emission sensor and at least one fiber-optic strain sensor is positioned. In various examples, UAV 10 can be a winged craft, a rotorcraft, and/or or a hybrid aircraft that is capable of transporting inventory by air from an origination location to a destination location.

In various examples, the UAV 10 can also include physical systems (not shown), such as a conventional control system and one or more conventional power module(s). The control system can be configured to control the operation, routing, and/or navigation of the UAV. Similarly, the power module(s) can be coupled to and can provide power for the UAV 10 control system and for the electric motors that power the propellers. In optional aspects, it is contemplated that the power module(s) can be in the form of battery power, solar power, gas power, super capacitor, fuel cell, alternative power generation source, or a combination thereof.

In embodiments, each fiber optic strain sensors is configured to measure strain associated with physical impact events upon the outer surface 36 of the skin 32 of a panel upon which the fiber optic strain gauge is mounted (upon the inner surface 34 of the skin 32 of the panel). In embodiments, the fiber optic strain gauge can be used to determine the location of a physical impact event on the skin of the panel by an analysis of the various sensed changes along the length of the predetermined patter of the fiber optic strain gauge. Identification of the identified impact location on the respective panel can result from an analysis of the multiple sensed changes that are identified in the predetermined pattern of the fiber optic strain gauge that is positioned thereon the inner skin 34 of the panel. In other embodiments, data from the fiber optic strain gauge can be conventionally used to determine the impact energy level that was applied to the identified impact location of the skin of the panel resulting from the physical impact event.

In some embodiments, the UAV 10 can include one or more processor(s) 50 operably connected to computer-readable media memory 52. The UAV 10 can also include one or more interfaces 54 to enable communication between the UAV 10 and other networked devices or systems, such as the impact detection system 100. The one or more interfaces 54 can include network interface controllers (NICs), I/O interfaces, or other types of transceiver devices to send and receive communications over a network. For simplicity, other computers are omitted from the illustrated UAV 10.

The computer-readable media memory 52 can include volatile memory (such as RAM), non-volatile memory, and/or non-removable memory, implemented in any method or technology for storage of information, such as computer-readable instructions, data structures, program modules, or other data. Some examples of storage media that may be included in the computer-readable media include, but are not limited to, random access memory (RAM), read only memory (ROM), electrically erasable programmable read only memory (EEPROM), flash memory or other memory technology, compact disk (CD-ROM), digital versatile disks (DVD) or other optical storage, magnetic cassettes, magnetic tape, magnetic disk storage or other magnetic storage devices, or any other medium which can be used to store the desired information and which can be accessed by a computing device.

In some embodiments, the computer-readable media memory 52 can include an operating system and a data store. The data store can be used to locally store sensor data that corresponds to sensor measurements.

In some embodiments, the impact detection system 100 described herein overcomes the deficiencies of the existing solutions by causing the processor 50 to execute one or more of the following steps: aggregating AE sensor derived impact data and strain derived impact event data, that describe the location and applied energy levels on the panels forming the UAV 10, which results from impact events thereon the outer surface 36 of the panels 30 of the UAV; whether maintenance on the UAV 10 is required as a result of the sensed impact event, and providing a report to an end user (e.g., using a WebAPI and/or GUI).

In some embodiments, the AE sensor derived impact data and strain derived impact data can be received on a periodic or continual basis. It is contemplated that the AE sensor data and strain data can be received when the UAV 10 is in flight and or not in flight and the AE sensor derived impact data and strain derived impact data can be subsequently derived. In additional aspects, it is contemplated that the AE sensor derived impact data and strain derived impact data can generally describe degradation in the state of panels 30 of the UAV.

It is contemplated that the impact detection system 100 has access to UAV design data that describes the materials that the panels 30 and/or skin 32 of the panels is formed from and that further describes historic data that identifies location and the applied energy state of impacts on respective panels forming the UAV. The UAV design data is digital data that describes Computer-aided Design (CAD) data and multiple simulation/test results for impact events on each panel 30 of the UAV 10. Based on the design data, the impact detection system 100 can determine the relative location of an impact vent on the outer surface 36 of the panel 30 and can derive the applied energy at that location on the panel by the impact event.

In some embodiments, the impact detection system 100 includes systems and sensors that monitor the condition of the skin 32 of the panels of the UAV 10. In some embodiments, for panels that have a mounted AE sensor and a mounted fiber-optic strain sensor, a communication unit of the UAV 10 receives acoustic emission (AE) sensor data from the mounted AE sensor and fiber-optic strain sensor data from the mounted fiber-optic strain sensor via a network which communicatively couples the communication unit to the systems and the sensors of the respective “wired” panel. The acoustic emission (AE) sensor data and fiber-optic strain sensor data is digital data that can include: (1) AE sensor data that describes the measurements recorded by the UAV's AE sensors, which are indicative of the location of and the level of the applied impact energy data on the outer surface 36 of the skin 32 of the panel, and (2) stain sensor data describes the measurements recorded by the UAV's strain sensors, which are also indicative of the location of and the level of the applied impact energy data on the outer surface 36 of the panel 30.

In some embodiments, the processor 50 includes software instructions to communicate with the communication unit of the UAV 10 to aggregate and, optionally, timestamp the acoustic emission (AE) sensor data and fiber-optic strain sensor data and to subsequently transmit the acoustic emission (AE) sensor data and fiber-optic strain sensor data back to the impact detection system 100 for storage and execution by a server that is communicatively coupled to a wireless and/or wired network. For example, the processor 50 can be programmed to communicate aggregated and, optionally, timestamped sets of the acoustic emission (AE) sensor data and fiber-optic strain sensor data back to the impact detection system 100 (which can operate on a cloud server) at regular intervals via Wi-Fi™, 3G, 4G, Long-term Evolution (LTE), 5G, Direct Short Range Communication (DSRC) or some other form of wireless and/or wired communication. In another embodiment, the acoustic emission (AE) sensor data and fiber-optic strain sensor data can be reported back to the impact detection system 100 on a periodic basis, a continual basis, and/or when requested by an operator. Accordingly, the acoustic emission (AE) sensor data and fiber-optic strain sensor data function as a source of digital data for the impact detection system 100 that describes the degradation of the panels forming the UAV resulting from an impact event.

In some embodiments, the impact detection system 100 includes software stored on a non-transitory memory 52. The non-transitory memory is an element of a processor-based computing device such as a server or cloud server. The impact detection system 100 includes code and routines that are operable, when executed by a processor 50 of the computing device, to cause the processor 50 to receive digital data that describes the location and applied energy levels onto a portion of the skin 32 of a panel 30 of the UAV that includes attached (AE) sensor(s) and fiber-optic strain sensor(s).

The impact detection system 100 includes any digital data and information that is necessary to generate an analysis of an impact event thereon the skin 32 of a respective panel 30 of a UAV, and, more particularly, to generate an analysis of an impact event thereon the panel of a UAV that denotes the location of the impact event on the outer surface 36 of the panel 30 as well as the magnitude of the energy level of the impact event there at the identified location of the impact event. In embodiments, the impact detection system 100 includes code and routines that are operable to determine the location of the impact event on the panel as well as the magnitude of the energy level of the impact event from the acoustic emission (AE) sensor data as an input and to the determine the location of the impact event on the panel as well as the magnitude of the energy level of the impact event from the fiber-optic strain sensor data as an input. The resulting derived location of the impact event and magnitude of the energy level of the impact event resulting from both the AE sensors and the fiber optic stain sensors are subsequently compared and analyzed to generate a high confidence level location of the impact event on the panel and magnitude of energy level of the impact event.

In embodiments, the impact detection system 100 can provide a GUI interface for end operators that can be configured to allow end users the ability to request reports from the impact detection system. The report data can be digital data that describes at least one of: the mechanical condition (or state) of the panels of the UAV, and whether the panels of the UAV will require maintenance in the future. The impact detection system can generate the report data based on each of the high confidence level determinations regarding the location of the impact event on the panel(s) and the determined magnitude of the energy level of the impact event.

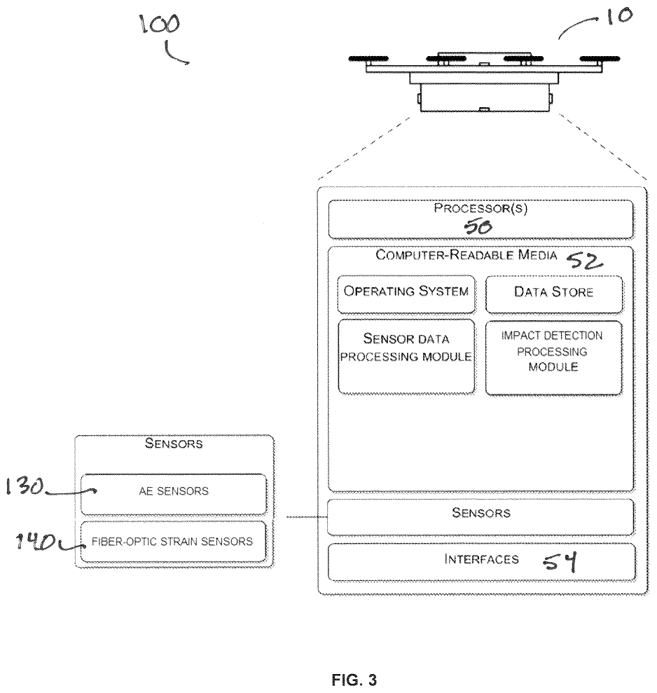

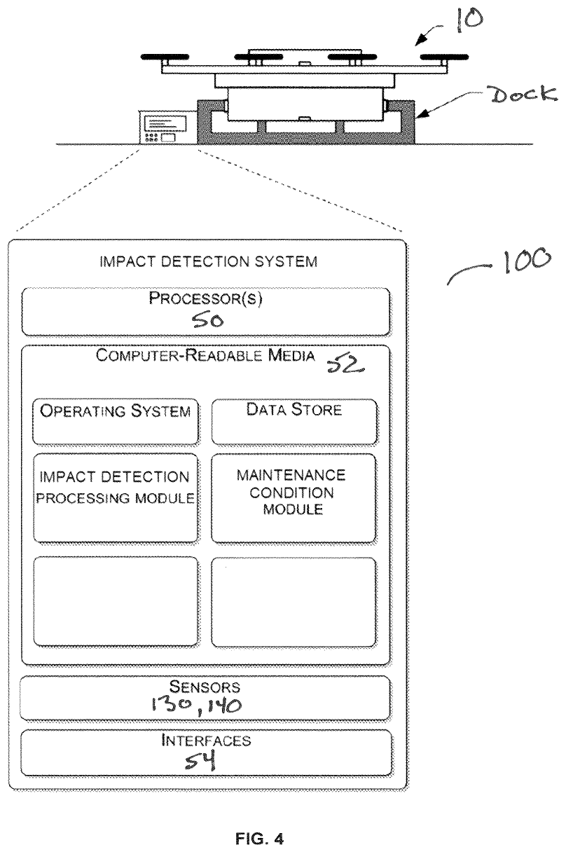

In some embodiments, the processor 50 and the memory 52 can be elements of a UAV computer system that can be operable to cause or control the operation of one or more of the following elements: one or more fiber optic strain sensors, one or more AE sensors, the communication unit; the processor 50; and the memory 52. The UAV computer system can be operable to access and execute the data stored on the memory 52 to provide the functionality described herein. In aspects, the UAV computer system can be configured to be operable to execute one or more of the steps of the method 300 described below with reference to FIGS. 3 and 4. As discussed above, the fiber optic strain measurement sensors and the acoustic emission sensors of the UAV 10 aid in detecting impact events thereon the UAV 10 and particularly in identifying the location and magnitude of the applied energy on the panel(s) 30 of the UAV 10 of the detected impact event(s).

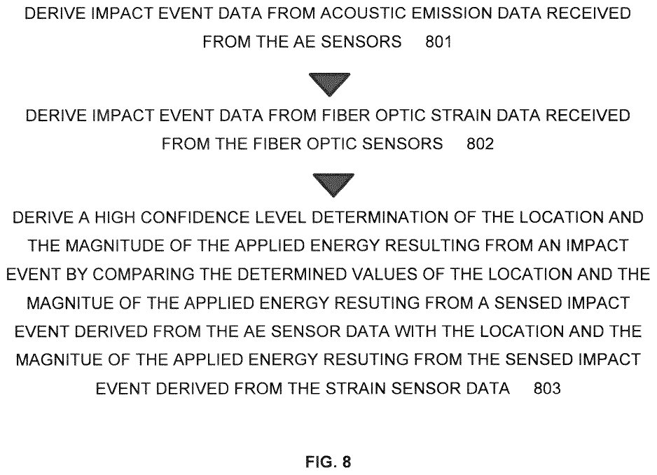

Referring to FIG. 8, in exemplary aspects, in a first Step 801, the processor 50 of the UAV 10 is programmed to derive impact event data from acoustic emission data that is received from the AE sensors. In this step, it is contemplated that the processor 50 can be programmed with probabilistic machine learning algorithms that can be applied to the acoustic emission data to determine the impact event data, which data is indicative of applied impact loads being applied to at least a portion of the outer surface 36 of the panel 30 of the UAV 10 and the location of the impact event thereon the outer surface 36 of the panel of the UAV.

In a second Step 802, the processor 50 of the UAV 10 is programmed to derive impact event data from fiber optic strain data received from the fiber-optic strain sensors. In this step, it is contemplated that the processor 25 can be programmed with algorithms that can be applied to the fiber optic strain data to determine the impact event data, which fiber optic strain data is indicative of applied impact loads being applied to at least a portion the outer surface 36 of the panel of the UAV and the location of the impact event thereon the outer surface 36 of the panel of the UAV relative to the pattern of the fiber optic stain sensor that is mounted on the inner surface 34 of the respective panel.

In a third Step 803, the processor 25 of the impact detection system 100 can be programed with instructions that when executed derives a high confidence level determination of the location and the magnitude of the applied energy resulting from the impact event by comparing the determined values of the location and the magnitude of the applied energy resulting from the impact event derived from the AE sensor data with the determination of the location and the magnitude of the applied energy resulting from the impact event derived from the actual stain measurements provided by the strain measurement sensors. In this step, it is contemplated that the processor 50 can be programmed with regression algorithms that can be applied to the location/energy applied results obtained from the AE sensor data and the fiber optic strain data to determine a high confidence level determination of the location and the magnitude of the applied energy resulting from the impact event.

In the first Step 801, it is contemplated that processor 50 of the impact detection server can be programed with instructions that when executed allow for the determination of the impact event based on the AE sensor data captured by the AE sensors deployed on respective panels of the UAV as an impact event occurs on the UAV. In exemplary aspects, it is contemplated that the processor 50 can be programed to apply a probabilistic machine learning algorithm, such as a random forest probabilistic machine learning algorithm, for this determination of the location of the impact event and the energy applied to the location by the impact event based on the AE sensor data. Exemplarily, it is contemplated the programed probabilistic machine learning algorithm can receive the AE sensor data stream, which can contain at least one real-time AE data signal generated by the respective AE sensors as an impact event occurs on a panel of the UAV. In operation, the programed probabilistic machine learning algorithm can process the real-time AE data signal(s) and can generate impact event data that is indicative of applied impact loads being applied to at least a portion of the outer surface 36 of the panel 30 of the UAV 10 and the location of the impact event thereon the outer surface 36 of the panel of the UAV.

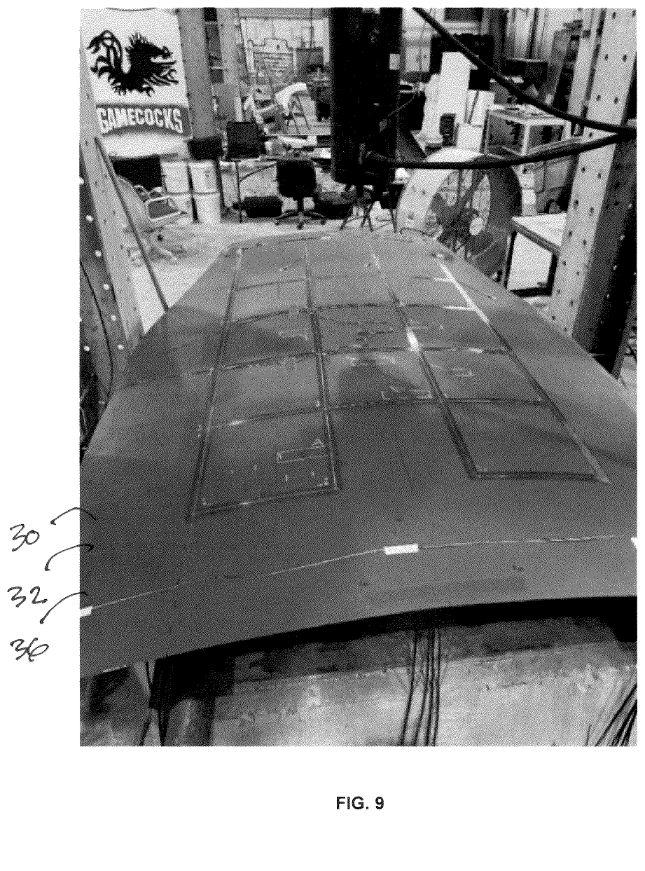

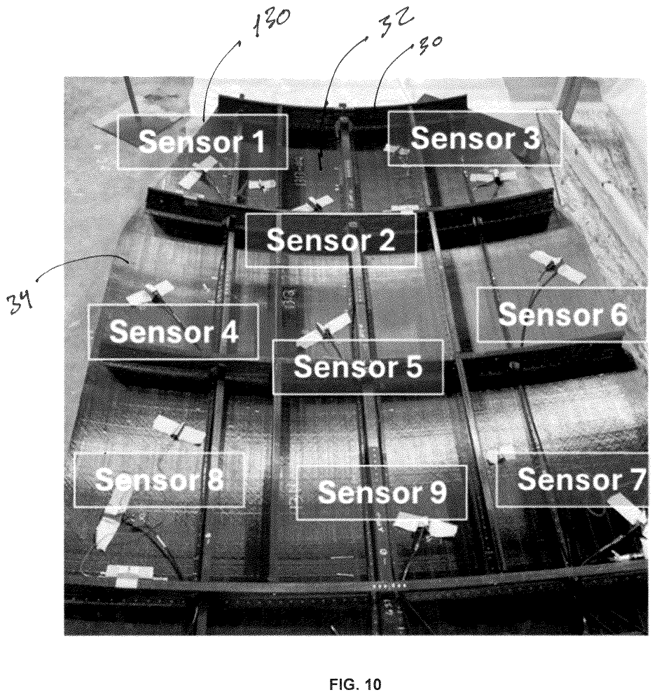

The method described in step 801 was evaluated under laboratory conditions to assess the efficacy of impact localization methodologies and to train algorithms. Referring to FIGS. 9 and 10, a training approach involving steel sphere impacts on a demonstrator panel specimen was employed to train and also to assess the proposed impact localization approach. Spheres were consistently positioned at 0.610 m (24.0 in.) from the surface. In this experiment, the smallest sphere had a diameter of 0.006 m (0.250 in.), the medium sphere had diameter of 0.013 m (0.500 in.), and the largest had a diameter of 0.019 m (0.750 in.).

The impact energies for the small, medium, and large spheres were 0.006, 0.050, and 0.170 Joules, respectively. A guide tube was utilized to regulate the location and height of each impact. The demonstrator panel specimen featured sixteen sections with one distinct impact point in each section. Acoustic emission sensors were affixed to the inner surface of the demonstrator panel specimen, with a total of nine sensors employed. Each impact location was subjected to 60 impacts per sphere size on each of the twelve impact points, resulting in a total of 2,160 impacts on the demonstrator. AE signals from utilized PKWDI sensors were recorded by an acoustic emission data acquisition system, using the AE system from the MISTRAS Group Inc. The PKWDI AE sensor was selected for noise reduction and low power consumption.

In the experimental setup, for the utilized PKWDI sensors, the amplitude threshold was configured at 32 dB with a sampling rate of 1 MHZ; a pre-trigger time of 256 μs was established to capture signal initiation; and a peak definition time (PDT), representing the duration from threshold crossing to peak amplitude, was set at 200 μs. Further, a signal duration of 2,000 μs was employed to identify the peak, while the hit definition time (HDT), which governs the termination of impact recording, was configured at 400 μs. Still further, signal recording commenced when the voltage exceeded the threshold value and ceased when the HDT parameter duration elapsed without additional threshold crossing and the hit lockout time (HLT) was established at 400 μs to minimize reflected hits and late-arriving signals.

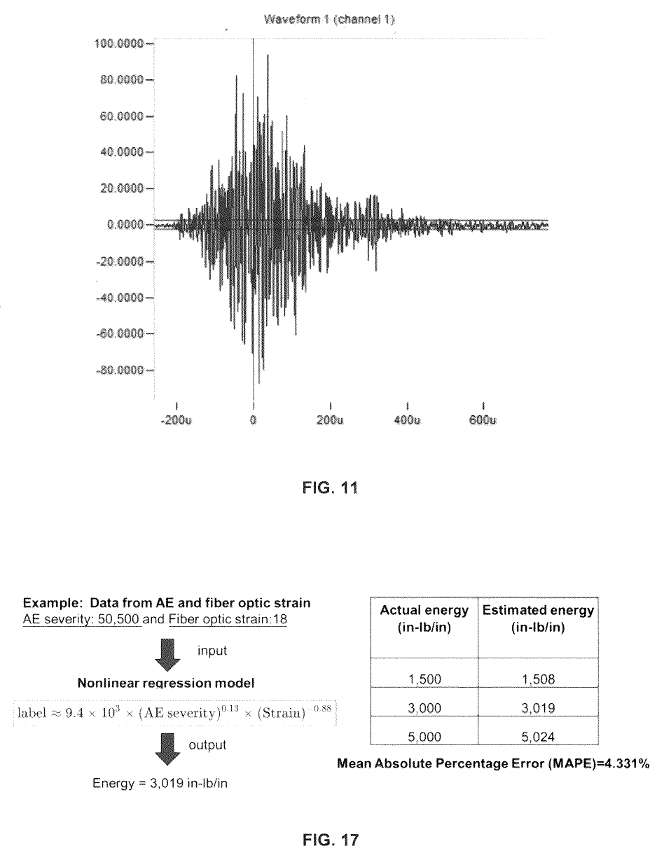

FIG. 11 shows a representative waveform recorded during an impact event on the panel specimen. AE signals were processed to extract relevant features. The purpose was to distill the complex information embedded within the waveform signal into a set of specific representative values that effectively capture the properties of the AE signal. In the present disclosure and as contemplated in Step 801, a plurality of features were selected to be used from features amplitude, average signal level, root mean square, energy, signal strength, absolute energy, rise time, duration, counts, counts to peak, average frequency, centroid, reverberation frequency, and initial frequency were derived from the signal. These features are selected as they have shown positive performance for source localization of the impact event.

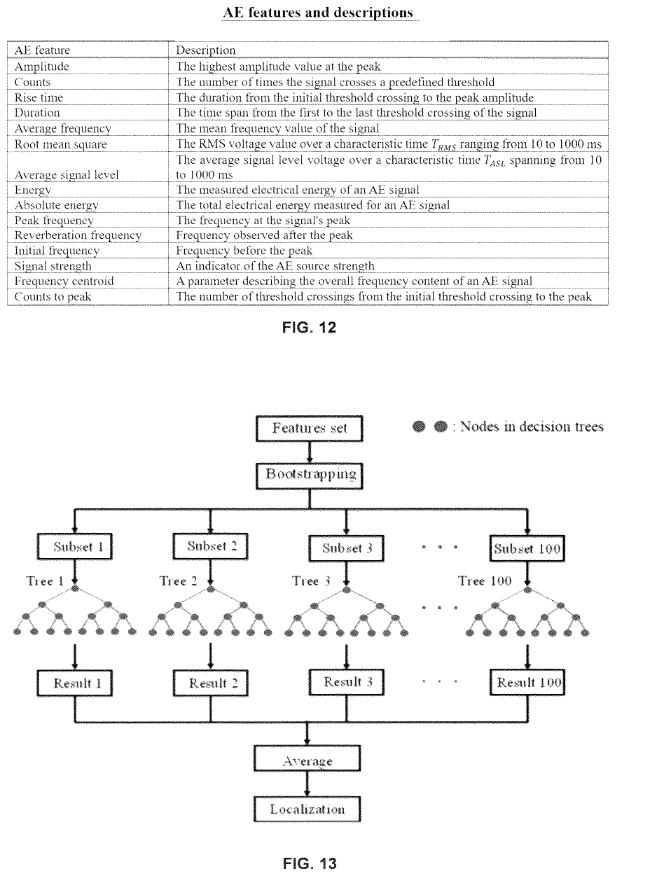

In the present disclosure, and as used in the experimental setup, the feature-based analytic approach (versus waveform based analysis) was utilized because it is significantly less computationally expensive (up to 90% less). Results are obtained generally in less than two seconds for analysis versus three to four hours for conventional waveform analysis. While waveform based methods can typically do result in higher accuracy, the saved storage and speed of feature-based processing allows for efficient processing of large datasets making it more practical for in-flight, real-time, and other time-sensitive applications. A list of features, along with their descriptions, is provided in FIG. 12. These features were selected as they have shown positive performance for source localization.

In this experimental test, the programed probabilistic machine learning algorithm used was random forest. The use of a random forest algorithm, an ensemble learning technique, allows for the construct of multiple decision trees during training by utilizing bootstrapping and random feature selection. Through this process it creates diversity among the trees, reducing the risk of overfitting while maintaining predictive accuracy. By aggregating the predictions of these trees through voting or averaging, the random forest algorithm, used by Step 801, strikes a balance between bias and variance, and can deliver reliable predictions with minimal tuning. In the experimental set up, the random forest algorithm was applied to predict impact locations based on AE features. FIG. 13 presents the structure of a random forest regression model with 100 decision trees.

Experimentally, the use of single AE sensor was studied. It was found that a single AE sensor disposed on the panel provided an accuracy level with respect to localization of the impact event onto the panel and the magnitude of the energy resulting from that impact event provided an accuracy level of at least 90%, and particularly of at least 94.3%.

While incorporating data from additional AE sensors mounted onto the same panel into the dataset during impact localization and analysis can enhance accuracy, the additional AE sensors come with increased cost and weight. Figure C illustrates the impact of increasing the number of AE sensors mounted onto the same panel on localization accuracy, cost, and weight.

It is evident that as the number of sensors increases localization accuracy also improves, as do cost and weight. Trade-offs between localization accuracy, cost and weight must be managed based on the requirements and desires of specific AAM vehicle manufacturers with consideration to factors including energy of the impact event and potential consequence for a specific location.

In Step 801, the method for estimating energy of the impact with acoustic emission signals is based on intensity analysis, which has demonstrated effectiveness in numerous applications. The intensity analysis entails computing two key metrics: severity (Sr) and the Historic index (H (t)), both metrics are derived from AE sensor signal strength measurements. Severity is calculated as the mean of fifty events with the highest signal strength. This severity parameter is dynamic and can be continuously updated with the recording of new AE sensor data signals. A notable increase in severity often correlates with the initiation or detection of damage resulting from an impact event. Conversely, the historic index parameter estimates changes in the slope of recorded signal strength and compares the strength of recent hits with the cumulative signal strength of all recorded hits. The historic index can assess and quantify spikes in cumulative signal strength, thereby providing an assessment of damage. The calculations for historic index and severity are provided in Eq. 1 and Eq. 2, respectively. The intensity of AE data can potentially be visualized by plotting the maximum severity-historic index obtained during each flight.

$${S}_{r} = \frac{1}{50} {\sum }_{i = 1}^{i = 50} {S}_{o i} \qquad ( 1 )$$

$$H ( t ) = \frac{N}{N - K} \frac{{\sum }_{i = K + 1}^{N} {S}_{o i}}{{\sum }_{i = 1}^{N} {S}_{o i}} \qquad ( 2 )$$

In this context, N represents the total number of hits recorded up to a specific time point (t), while Soi denotes the signal strength of the i-th event. The factor K is determined empirically and varies depending on the number of hits. For Step 801, suggested values for K have been established as follows: (1) K is not applicable when N≤50; (2) K is set to N-30 if 51≤N≤200; (3) K is calculated as 0.85N when 201≤N≤500; and (4) K is N-75 for N≥501. This algorithm can be provided as in-flight data and can be collected and/or streamed continuously, resulting in more realistic values for Historic index.

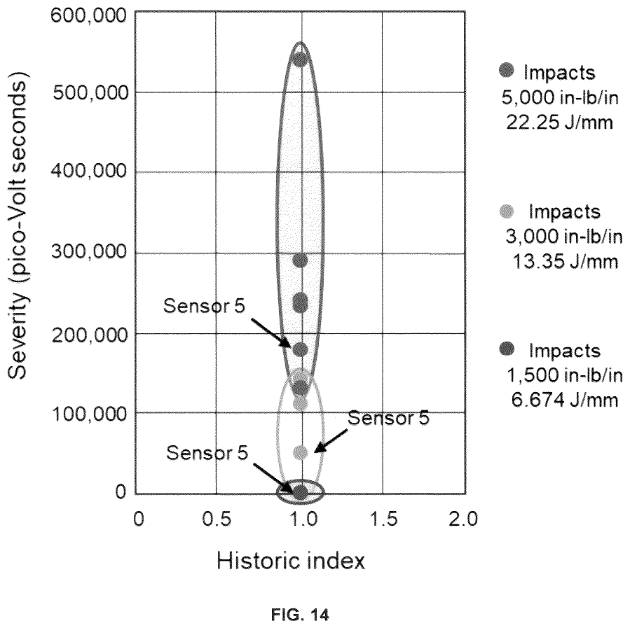

Intensity analysis was performed on the AE signals generated through different energy impacts obtained from the experiment setup using multiple AE sensors on the panel and the results are shown in FIG. 14. The points in the figure represent severity based on AE signals received by sensors under different impact energies. The red points correspond to an impact energy of 22.25 J/mm (5,000 in-lb/in) and indicate that eight sensors detected signals with severity values ranging from 120,000 to 550,000 pico-Volt seconds (some points overlap). The severity detected by sensor five, which is used for impact localization, is 163,000 pico-Volt seconds. The yellow points correspond to an impact energy of 13.35 J/mm (3,000 in-lb/in), indicating that nine sensors detected signals, with severity values ranging from 0 to 130,000 pico-Volt seconds, and sensor five recorded severity of 50,500 pico-Volt seconds. The green points, corresponding to an impact energy of 6.674 J/mm (1,500 in-lb/in) also indicate nine sensors detecting signals; however, all green points overlap, indicating that the severity value for all sensors, including sensor five is pico-Volt seconds. In this experimental set up, the Historic index is the same for all three energies as the number of hits is less than 50, therefore the energy of the impacts can be estimated through severity alone. The severity of the signals due to different impacts is distributed in different value intervals, allowing for an approximation of the impact energy.

In the second Step 802, it is contemplated that processor 50 of the impact detection system 10 can be programed with instructions that when executed allow for the determination of the impact event based on the fiber optic strain sensor data captured by the fiber optic strain sensors deployed on respective panels of the UAV as an impact event occurs on the UAV.

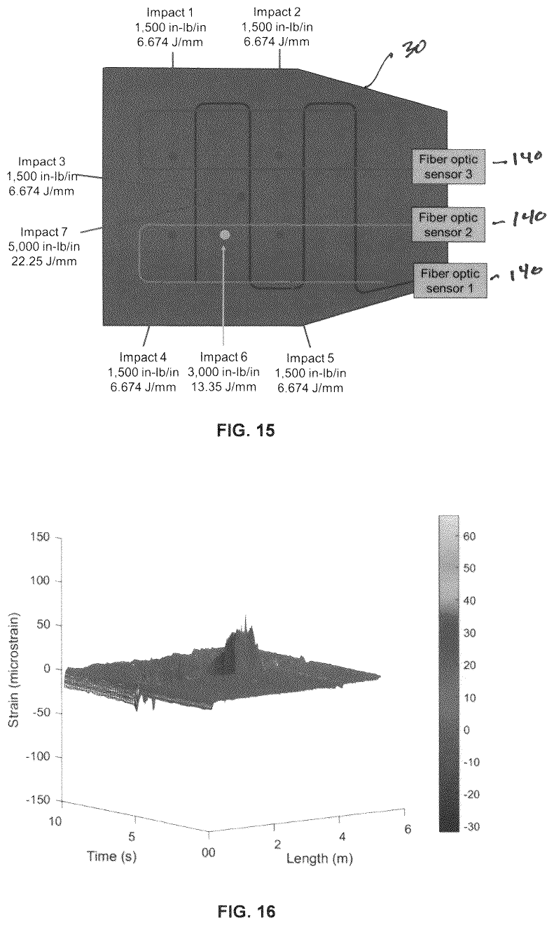

In exemplary aspects. As shown in FIG. 15, three high-definition fiber optic sensors were affixed to the lower surface of the demonstrator panel in an overlapping pattern and interrogated (using an ODiSI interrogator from Luna Innovations). In operation of Step 802, only one high-definition fiber optic sensors is preferably affixed to the lower surface of the panel 32, and the preferred pattern is the serpentine pattern identified as the “Fiber optic sensor 1”. Exemplary strain captured by a fiber optic sensor prior to, during, and after an impact event is shown in FIG. 15. The length axis represents the entire elongate length of the fiber optic sensor. The effect of the impact event is clear in terms of both magnitude and location. To improve estimation of impact energy and localization, strain data gathered from high-definition fiber optic sensors (such as high-definition fiber optic sensors obtained from Luna Innovations) can be combined with the derived AE data. FIG. 16 shows an exemplary fiber optic sensor reading based on a typical impact event.

In a third Step 803, the processor 25 of the impact detection system 100 can be programed with instructions programed to apply a non-linear regression algorithm to the determined values of the location and the magnitude of the applied energy resulting from the impact event derived from the AE sensors data with the determination of the location and the magnitude of the applied energy resulting from the impact event derived from the actual stain measurements provided by the strain measurement sensors. The regression model provides a numerical estimation of the impact energy.

FIG. 17 depicts the data combination (fusion) and nonlinear regression process that occurs in Step 803 to derive a high confidence level determination of the location and the magnitude of the applied energy resulting from the impact event. The input for the nonlinear regression model consists of derived AE data and derived fiber optic strain data, while the output for the nonlinear regression model represents the numerical value of impact energy. FIG. 17 shows an example where AE data and fiber optic strain data corresponding to 13.35 J/mm (3,000 in-lb/in) are fed into the regression model, and the output correctly identifies the impact energy as 13.43 J/mm (3,019 in-lb/in), which is close to the actual condition. Further, FIG. 17 shows a comparison of predicted vs. actual energy for each of the three levels. The mean absolute percentage error (MAPE)=4.33%, in other words, the accuracy of energy estimation is 1-MAPE=95.7%.

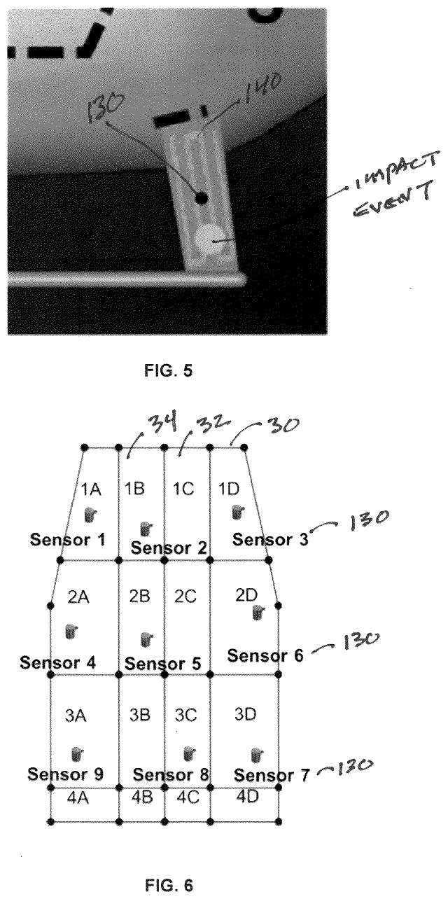

In embodiments, it is contemplated that the impact detection system 100 can be used for in-flight localization and characterization (energy level) of low-velocity impact events on panels of the UAV. In this way, the respective AE sensors can serve two roles, first for the detection of impact events and second for the of assessing damage associated with those events. To achieve the goal of minimally intrusive sensing, and as described above, machine learning algorithms based on acoustic emission signal features are used to reduce the number of required AE sensors and to reduce the computational complexity. It is contemplated that AE sensor data for in-flight impact can be gathered continuously at sampling rates in the range of 500,000 to 1 million samples per second. Further, the impact detection system can include fiber optic strain sensors that are generally light in weight and can capture displacement, vibration, and static/dynamic strain with sensor scan rates in the range of about 5,000 samples per second. High-definition fiber optic strain sensors can detect strain information at high resolution (˜ each 0.65 mm) and interrogators for this type of high-definition fiber optic strain sensor can operate at sampling rates of 60 to 250 samples per second. Representative exemplary positions of the AE sensors and fiber optic strain sensors are shown in FIGS. 4-7.

In a further step, the impact detection system 100 can be programmed to notify an operations center of a detected failure condition resulting from one or more impact events. The impact detection system 100 can also be programmed to cause a modification to a maintenance plan associated with the UAV 10. In this aspect, the maintenance plan modification can include scheduling a corrective action.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification can be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features can have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method comprising:
receiving sensor data from a plurality of sensors associated with an unmanned aerial vehicle (UAV), wherein the plurality of sensors comprises at least one acoustic emission (AE) sensor and at least one fiber-optic strain sensor, wherein the plurality of sensors is attached to an inner surface of a panel that forms a portion of a fuselage of the UAV;
receiving AE sensor data indicating a detection of an impact event has occurred on an outer surface of the panel that is sensed by at least one AE sensor positioned thereon the UAV;
from the received acoustic emission sensor data, determining AE sensor derived impact event data that is indicative of applied impact loads being applied to at least a portion of the outer surface of the panel of the UAV and a location, relative to the at least one AE sensor, of the impact event thereon the outer surface of the panel of the UAV;
receiving strain impact event sensor data from the impact event that is sensed by at least one fiber optic strain sensor positioned thereon the UAV;
from the received strain impact event sensor data, determining strain impact event data that is indicative of applied impact loads being applied to at least a portion of the outer surface of the panel of the UAV and a location, relative to the at least one fiber optic strain sensor, of the impact event thereon the outer surface of the panel of the UAV; and
determining and validating a high confidence level determination of the location and the magnitude of the applied energy resulting from the impact event from the determined AE sensor derived impact event data values and the determined strain impact event data values.

2. The method of claim 1, further comprising generating a report describing a maintenance condition of the UAV based on the impact event, wherein the report includes a damage prediction to the panel based on the based on the high confidence level determination of the location and the magnitude of the applied energy resulting from the impact event.

3. The method of claim 1, wherein the step of determining AE sensor derived impact event data comprises applying a probabilistic machine learning algorithm that is configured to determine the location of the impact event relative to the AE sensor and to determine the magnitude of the energy applied at the location by the impact event based on the AE sensor data.

4. The method of claim 3, wherein the probabilistic machine learning algorithm is a random forest probabilistic machine learning algorithm.

5. The method of claim 3, wherein the step of determining AE sensor derived impact event data comprises analyzing AE sensor data that is in a waveform format, and wherein a plurality of features of the waveform are identified and analyzed using the probabilistic machine learning algorithm to determine the AE sensor derived impact event data.

6. The method of claim 5, wherein the plurality of features derivable from the AE sensor data in the waveform format includes amplitude, average signal level, root mean square, energy, signal strength, absolute energy, rise time, duration, counts, counts to peak, average frequency, centroid, reverberation frequency, and/or initial frequency.

7. The method of claim 1, wherein the step of determining impact loads derived from AE sensor derived impact event data comprises applying an intensity analysis, and wherein the intensity analysis computes a severity value and a historic index value from the strength of the AE sensor data signals.

8. The method of claim 1, wherein the determined strain impact event data is indicative of applied impact loads onto a portion the outer surface of the panel of the UAV and the location of the impact event thereon the outer surface of the panel of the UAV relative to a pattern of the fiber optic stain sensor that is mounted on the inner surface of the respective panel.

9. The method of claim 8, wherein the pattern of the fiber optic stain sensor that is mounted on the inner surface of the respective panel form a serpentine path.

10. The method of claim 1, wherein the step of determining and validating a high confidence level determination of the location and the magnitude of the applied energy resulting from the impact event comprises applying a non-linear regression algorithm to the determined AE sensor derived impact event data values and the determined strain impact event data values.

11. The method of claim 1, wherein one acoustic emission (AE) sensor and one fiber-optic strain sensor is attached to an inner surface of a panel that forms a portion of a fuselage of the UAV.

12. The method of claim 11, wherein UAV has a plurality of panels and wherein at least two of the plurality of panels of the UAV is configured with one acoustic emission (AE) sensor and one fiber-optic strain sensor.

13. An impact detection system comprising:
at least one AE sensor positioned hereon an inner surface of a panel of a UAV;
at least one fiber-optic strain sensor positioned hereon the inner surface of the panel of the UAV;
a non-transitory memory storing digital data recording post impact event acoustic emission sensor data generated by the at least one acoustic emission sensor and the strain impact event sensor data generated by the at least one fiber-optic strain sensor; and
a processor that is communicatively coupled to the non-transitory memory, wherein the non-transitory memory stores computer code which, when executed by the processor, causes the processor to:
determine AE sensor derived impact event data from the recorded acoustic emission sensor data, the AE sensor derived impact event data being indicative of applied impact loads being applied to at least a portion of the outer surface of the panel of the UAV and a location, relative to the at least one AE sensor, of the impact event thereon the outer surface of the panel of the UAV;
determine strain impact event data from recorded strain impact event sensor data, the strain impact event data being indicative of applied impact loads being applied to at least a portion of the outer surface of the panel of the UAV and a location, relative to the at least one fiber optic strain sensor, of the impact event thereon the outer surface of the panel of the UAV;
determine and validate a high confidence level determination of the location and the magnitude of the applied energy resulting from the impact event from values of the determined AE sensor derived impact event data and the determined strain impact event data; and
generate a report describing the condition of the panel of the UAV based on the high confidence level determination of the location and the magnitude of the applied energy resulting from the impact event.

14. The impact detection system of claim 13, wherein the processor applies a probabilistic machine learning algorithm that is configured to determine the location of the impact event relative to the AE sensor and to determine the magnitude of the energy applied at the location by the impact event based on the AE sensor data.

15. The impact detection system of claim 14, wherein the probabilistic machine learning algorithm is a random forest probabilistic machine learning algorithm.

16. The impact detection system of claim 14, wherein the digital data recording post impact event acoustic emission sensor data generated by the at least one acoustic emission sensor is in a waveform format, wherein the processor analyzes a plurality of features of the waveform to determine the AE sensor derived impact event data.

17. The impact detection system of claim 16, wherein the plurality of features includes amplitude, average signal level, root mean square, energy, signal strength, absolute energy, rise time, duration, counts, counts to peak, average frequency, centroid, reverberation frequency, and/or initial frequency.

18. The impact detection system of claim 13, wherein the determined strain impact event data is indicative of applied impact loads onto a portion the outer surface of the panel of the UAV and the location of the impact event thereon the outer surface of the panel of the UAV relative to a pattern of the fiber optic stain sensor that is mounted on the inner surface of the respective panel, and wherein the pattern of the fiber optic stain sensor that is mounted on the inner surface of the respective panel form a serpentine path.

19. The impact detection system of claim 13, wherein the processor applies a non-linear regression algorithm to the determined AE sensor derived impact event data values and the determined strain impact event data values to determine and validate the high confidence level determination of the location and the magnitude of the applied energy resulting from the impact event.

20. The impact detection system of claim 13, wherein one acoustic emission (AE) sensor and one fiber-optic strain sensor is attached to an inner surface of a panel that forms a portion of a fuselage of the UAV, wherein the UAV has a plurality of panels, and wherein at least two of the plurality of panels of the UAV is configured with one acoustic emission (AE) sensor and one fiber-optic strain sensor.
